(19) United States
(12) Patent Application Publication
(10) Pub. No.: US 2013/0145893 A1
(43) Pub. Date: Jun. 13, 2013

(54) CEILING-MOUNTED SCARA ROBOT

(71) Applicants: Yoshitaka Kumagai, Chiyoda-ku (JP); Mitsuhiro Fukatsu, Chiyoda-ku (JP)

(72) Inventors: Yoshitaka Kumagai, Chiyoda-ku (JP); Mitsuhiro Fukatsu, Chiyoda-ku (JP)

(73) Assignee: MITSUBISHI ELECTRIC CORPORATION, Chiyoda-ku, Tokyo (JP)

(21) Appl. No.: 13/817,939

(22) PCT Filed: Sep. 3, 2010
(86) PCT No.: PCT/JP2010/065142

§ 371 Date: Feb. 20, 2013

(51) Int. Cl. B25J 18/02

(52) U.S. Cl. CPC B25J 18/02
USPC 74/490.05

(57) ABSTRACT

A ceiling-mounted SCARA robot includes a base, a first arm that is connected to the base via a first coupling part centering around a first articulated shaft and that can pivotally move around the first articulated shaft as a center of pivotal movement within a horizontal plane, a second arm that is connected to the first arm via a second coupling part centering around a second articulated shaft and that can pivotally move around the second articulated shaft as a center of pivotal movement within a horizontal plane, a working shaft that is mounted on the second arm, and a base mounting part that is mounted on the base and places the base on a beam as a structural body for mounting located at a position vertically above an operating area of the working shaft.

### FIELD

The present invention relates to a ceiling-mounted SCARA robot.

### BACKGROUND

As a type of horizontal articulated industrial robots referred to as SCARA robots, a ceiling-mounted SCARA robot that is installed by being hung from a ceiling surface is known (see, for example, Patent Literatures 1 and 2).

### CITATION LIST

### Patent Literatures

Patent Literature 1: Japanese Patent Application Laid-open No. 2005-193347

Patent Literature 2: Japanese Patent Application Laid-open No. 6-262555

### SUMMARY

### Technical Problem

Conventionally, a ceiling-mounted SCARA robot requires a mounting surface (a machining surface) for mounting a robot on an undersurface of a ceiling surface structure. Because the mounting surface needs to be parallel to a working surface in an operating area of the robot, there is a problem that the ceiling surface structure becomes complicated such that, for example, the ceiling surface itself needs to be constructed to be parallel to the working surface. Furthermore, because the robot is mounted from an underside of the ceiling surface toward an upper side thereof, it is necessary to support the weight of the robot during a mounting operation until fixing of the robot by tightening a mounting bolt or the like is completed.

The present invention has been achieved in view of the above problems, and an object of the present invention is to provide a ceiling-mounted SCARA robot that can be installed by an easy mounting operation while using a simple configuration.

### Solution to Problem

In order to solve the afore-mentioned problems, a ceiling-mounted SCARA robot comprising: a base; a first arm that is connected to the base via a first coupling part centering around a first articulated shaft and that can pivotally move around the first articulated shaft as a center of pivotal movement within a horizontal plane; a second arm that is connected to the first arm via a second coupling part centering around a second articulated shaft and that can pivotally move around the second articulated shaft as a center of pivotal movement within a horizontal plane; a working shaft that is mounted on the second arm; and a base mounting part that is mounted on the base and places the base on a structural body for mounting located at a position vertically above an operating area of the working shaft, wherein in an accommodated state where the second arm is accommodated under the first arm such that directions of an arm length of the first arm and an arm length of the second arm are set to match each other, respective constituent elements opposing to the base with respect to the base mounting part can be assembled within a range of a length of the base mounting part at least in one of directions included in a horizontal direction.

### Advantageous Effects of Invention

The ceiling-mounted SCARA robot according to the present invention can be installed by an easy mounting operation while using a simple configuration.

### BRIEF DESCRIPTION OF DRAWINGS

FIG. 1 is a front view of a ceiling-mounted SCARA robot according to an embodiment of the present invention.

FIG. 2 is a side view of the ceiling-mounted SCARA robot.

FIG. 3 is a top view of a base and a base mounting part.

FIG. 4 is an explanatory diagram of mounting of the ceiling-mounted SCARA robot.

### DESCRIPTION OF EMBODIMENTS

Exemplary embodiments of a ceiling-mounted SCARA robot according to the present invention will be explained below in detail with reference to the accompanying drawings. The present invention is not limited to the embodiments.

Embodiment.

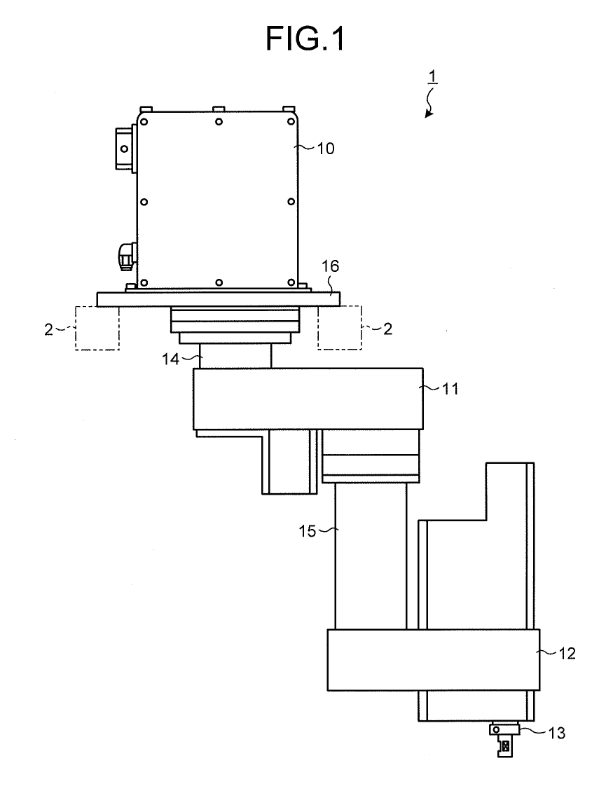

FIG. 1 is a front view of a ceiling-mounted SCARA robot according to an embodiment of the present invention.

The ceiling-mounted SCARA robot 1 includes a base 10, a first arm 11, a second arm 12, and a working shaft 13. The first arm 11 is connected to the base 10 via a first coupling part 14 that centers around a first articulated shaft. The first arm 11 can pivotally move around the first articulated shaft as a center of pivotal movement within a horizontal plane. A motor and a reducer (both not shown) for driving the first arm 11 are fixed to the base 10.

The second arm 12 is connected to the first arm 11 via a second coupling part 15 that centers around a second articulated shaft. The second arm 12 can pivotally move around the second articulated shaft as a center of pivotal movement within a horizontal plane. A motor and a reducer (both not shown) for driving the second arm 12 are fixed to the first arm 11.

The working shaft 13 is arranged at a tip-end part of the second arm 12 to be able to move vertically and to rotate. A tool for conveying and machining workpieces is mounted on the working shaft 13. A motor and a reducer (both not shown) for driving the working shaft 13 are fixed to the second arm 12.

The arm length of the first arm 11 (a distance between the first articulated shaft and the second articulated shaft) and the arm length of the second arm 12 (a distance between the second articulated shaft and a center of the working shaft 13) are set to be equal. The first arm 11 and the second arm 12 are configured to pass by without interfering with each other because pivoting surfaces thereof are vertically shifted from each another.

A base mounting part 16 is mounted on an undersurface of the base 10. The base mounting part 16 is a plate-like member for placing the base 10 on two beams 2. The beam 2 is a structural body for mounting, located vertically above an operating area of the working shaft 13. For example, the two beams 2 are provided with a space to each other at positions that correspond to a ceiling surface of a working cell of the ceiling-mounted SCARA robot 1.

The base mounting part 16 is installed so as to cross between the two beams 2. The ceiling-mounted SCARA robot 1 is installed through the two beams 2 such that the base 10 above the base mounting part 16 is located above the beams 2 and respective constituent elements below the base mounting part 16 are located below the height of the beams 2.

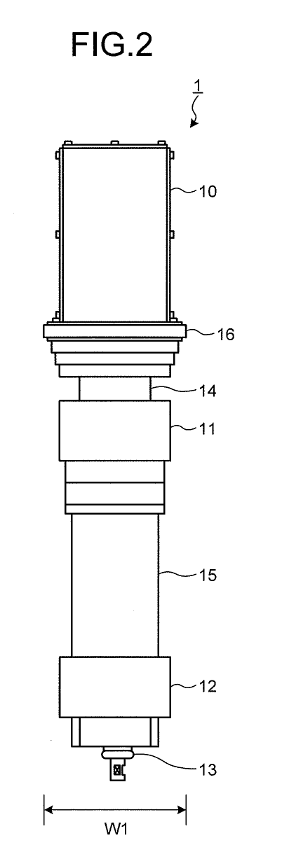

FIG. 2 is a side view of the ceiling-mounted SCARA robot. The side view in FIG. 2 depicts one of the sides in a state where the second arm 12 pivots 180 degrees from the state in FIG. 1 and is accommodated under the first arm 11 (hereinafter, this state is referred to as “accommodated state” as appropriate). In this state of the ceiling-mounted SCARA robot 1, for example, respective constituent elements are assembled within a range of a width W1 of the base mounting part 16 in a horizontal direction of a plane shown in FIG. 2. Each of the width of the first arm 11 and the width of the second arm 12 is set to be the equal to the W1 or narrower than the W1. The width of the first arm 11 and that of the second arm 12 represent a width in a direction that is perpendicular to a direction of the arm length (the depth direction of the drawing of FIG. 2) and is included in a pivoting surface (the horizontal direction of FIG. 2).

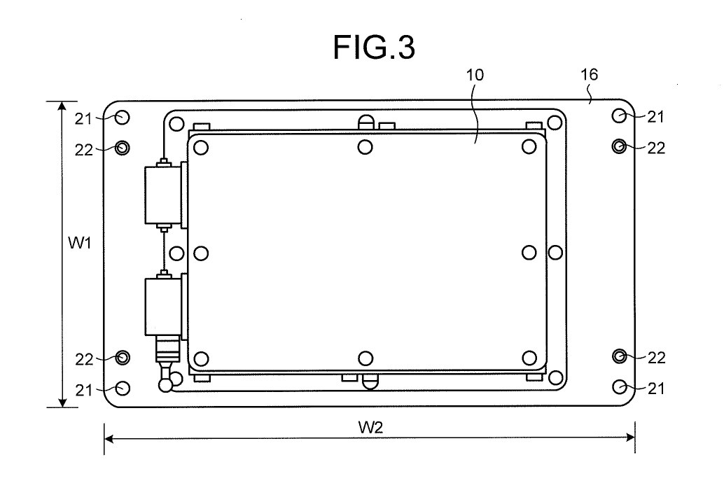

FIG. 3 is a top view of a base and a base mounting part. In a horizontal surface shown in FIG. 3, the base mounting part 16 substantially forms a rectangle in which a long side is represented as W2 and a short side is represented as W1 (W2>W1). Each of a long side direction and a short side direction of the base mounting part 16 is included in a horizontal direction.

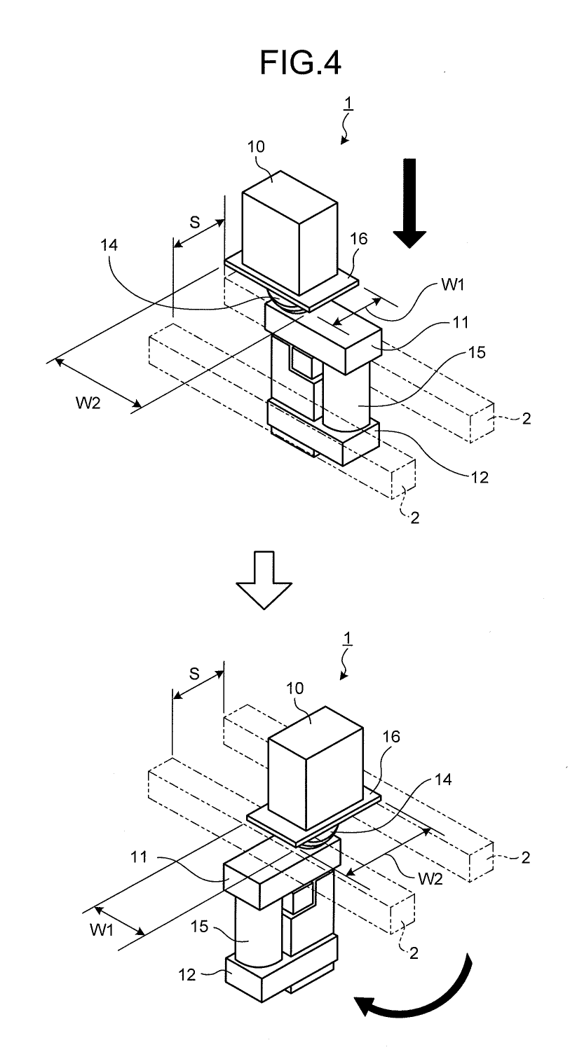

FIG. 4 is an explanatory diagram of mounting of the ceiling-mounted SCARA robot. A space S between the two beams 2 is set to be wider than the W1 and narrower than the W2 (W1<S<W2). First, as shown in the upper part in FIG. 4, the ceiling-mounted SCARA robot 1 is put through from a top side of the beams 2 to the space between the beams 2 in such a manner that directions of the arm length of the first arm 11 and the arm length of the second arm 12 that are in the accommodated state are set to match each other in a longitudinal direction of the beams 2.

After putting through the ceiling-mounted SCARA robot 1 in the space of the beams 2 to a position of the first coupling part 14, as shown in the lower part in FIG. 4, the ceiling-mounted SCARA robot 1 is caused to rotate 90 degrees in the horizontal direction. By rotating the ceiling-mounted SCARA robot 1, overhanging parts of the base mounting part 16 (both ends in the longitudinal direction) are placed on the beams 2, and accordingly the SCARA robot 1 is installed while being put through between the two beams 2. In this way, as the width of portions including the first arm 11 and the second arm 12 are set to be shorter and the base mounting part 16 is set to be longer than the space between the beams 2, it is possible to install the ceiling-mounted SCARA robot 1 from the top side of the beams 2.

The ceiling-mounted SCARA robot 1 can be also installed on the beams 2 by putting through the base 10 and the base mounting part 16 from the underside of the beams 2 and then rotating the ceiling-mounted SCARA robot 1. As the width of the whole ceiling-mounted SCARA robot 1 in the accommodated state is set to be narrower than the space between the beams 2, it is possible to install the ceiling-mounted SCARA robot 1 from both the top side and the underside of the beams 2.

It suffices that at least the arm width of the first arm 11 and that of the second arm 12 of the ceiling-mounted SCARA robot 1 are shorter than the length of at least one of the directions of the overhanging part of the base mounting part 16. In this case, by preparing beams 2 having a space between each other, which is longer than the arm width of the first arm 11 and that of the second arm 12 and shorter than the length of the base mounting part 16, it is possible to install the ceiling-mounted SCARA robot 1 from the top side of the beams 2.

As shown in FIG. 3, the base mounting part 16 includes fixing members 21 for mounting and jack-up members 22. The fixing member 21 for mounting fixes the base mounting part 16 to the beams 2. The jack-up member 22 functions as a position adjusting mechanism for adjusting a position of the base mounting part 16 with respect to a working surface of the working shaft 13.

The fixing members 21 for mounting include, for example, screws having penetrated through the base mounting part 16 and nuts for fixing the screws, and are provided at four corners of the base mounting part 16. The jack-up members 22 include, for example, screws having penetrated through the base mounting part 16, and are provided near the fixing members 21 for mounting. By appropriately adjusting tightening of the respective jack-up members 22 after placing the base mounting part 16 on the beams 2, the base mounting part 16 is positioned such that a mounting surface (an undersurface) of the base mounting part 16 becomes parallel to a working surface. Furthermore, the height of the base mounting part 16 with respect to the working surface can be adjusted by adjustment of the jack-up members 22.

By using the base mounting part 16, the ceiling-mounted SCARA robot 1 can be installed from the top side of the beams 2 while placing the base 10 on the beams 2. After placing the base mounting part 16 and the base 10 on the beams 2, an operator can perform a fixing operation without supporting the weight of the ceiling-mounted SCARA robot 1.

By using the jack-up members 22, the ceiling-mounted SCARA robot 1 can easily and precisely adjust the parallelism of the base 10 with respect to the working surface after placing the base mounting part 16 on the beams 2. Furthermore, only by construction of a ceiling surface and the beams 2, it becomes unnecessary to secure the parallelism with respect to the working surface, and thus it becomes possible to mount the ceiling-mounted SCARA robot 1 with a simple configuration. Accordingly, the ceiling-mounted SCARA robot 1 can be installed by an easy mounting operation while using a simple configuration.

The number and positions of the jack-up members 22 are not limited to those in the present embodiment described above and can be changed as appropriate. Furthermore, the position adjusting mechanism is not limited to the example of the jack-up members 22 using screws, but any configurations can be used as long as it is capable of adjusting at least one of the inclination and the height of the base mounting part 16.

The structural body for mounting is not limited to a case where the number of the beams 2 is two. As long as, at least portions of the ceiling-mounted SCARA robot 1 below the base mounting part 16 can be put through between the beams 2 so that the overhanging part of the base mounting part 16 can be placed on the beams 2, any structural body for mounting can be used. For example, as the structural body for mounting, a plate-like member having an opening thereon can be used.

The structural body for mounting is not limited to a case where it is installed in a working cell in which a working area for each robot is set as a unit. The structural body for mounting can be provided at any positions vertically above a working surface. For example, the structural body for mounting can be mounted on a ceiling surface of a working area where a plurality of robots work or mounted on a ceiling surface in a room.

### INDUSTRIAL APPLICABILITY

As described above, in the ceiling-mounted SCARA robot according to the present invention, it is possible to simplify a structure for mounting and an operation for mounting, and thus the ceiling-mounted SCARA robot is suitable for streamlining provision of a new or additional production line and an operation for replacement of robots or the like.

### REFERENCE SIGNS LIST

1 ceiling-mounted SCARA robot

2 beam

10 base

11 first arm

12 second arm

13 working shaft

14 first coupling part

15 second coupling part

16 base mounting part

21 fixing member for mounting

22 jack-up member

1. A ceiling-mounted SCARA robot comprising:
a base;
a first arm that is connected to the base via a first coupling part centering around a first articulated shaft and that can pivotally move around the first articulated shaft as a center of pivotal movement within a horizontal plane;
a second arm that is connected to the first arm via a second coupling part centering around a second articulated shaft and that can pivotally move around the second articulated shaft as a center of pivotal movement within a horizontal plane;
a working shaft that is mounted on the second arm; and
a base mounting part that is mounted on the base and places the base on a structural body for mounting located at a position vertically above an operating area of the working shaft, wherein
in an accommodated state where the second arm is accommodated under the first arm such that directions of an arm length of the first arm and an arm length of the second arm are set to match each other, constituent elements opposing to the base with respect to the base mounting part can be assembled within a range of a length of the base mounting part at least in one of directions included in a horizontal direction.

2. (canceled)

3. The ceiling-mounted SCARA robot according to claim 1, comprising a position adjusting mechanism that adjusts a position of the base mounting part with respect to a working surface of the working shaft.
